(19) United States
(12) Patent Application Publication
(10) Pub. No.: US 2011/0078154 A1
(43) Pub. Date: Mar. 31, 2011

(54) RECRUITMENT SCREENING TOOL

(75) Inventors: Simon Daniel Rickman, East Sussex (GB); Stephen Michael McLaughlin, West Midlands (GB)

(73) Assignee: Accenture Global Services GmbH, Schaffhausen (CH)

(21) Appl. No.: 12/568,093

(22) Filed: Sep. 28, 2009

(51) Int. Cl. G06F 17/30

(52) U.S. Cl. 707/748; 707/E17.071

(57) ABSTRACT

A recruitment screening tool is configured to generate a respective resume score for each of a plurality of candidate resumes based on a comparison of each resume to predetermined resume criteria by a candidate screener. The recruitment screening tool compares each respective resume score to a predetermined scoring scale having at least one scoring threshold. A candidate recruiter is notified of each resume having a respective resume score greater than the at least one scoring threshold. The recruitment screening tool is also configured to perform quality control functions with respect to the candidate screener. The tool is also configured to generate at least one statistic based on at least one analysis factor with respect to content of the candidate resumes.

### TECHNICAL FIELD

This application relates to a system used to screen candidates for employment, and more particularly, to a system used to screen candidates based on scoring criteria applied to candidate resumes.

### BACKGROUND

Employers having open positions for employment may be inundated with candidate resumes if the open positions are desirable or if economic conditions cause a large number of candidates to apply. Thus, employers' recruiters may be required to manually review a cumbersome amount of resumes. In some instances, recruiters may employ one or more candidate screeners to initially manually screen candidate resumes. However, candidate screeners may operate without any particular objective criteria on which to evaluate the resumes. Operating in this manner may result in inconsistencies due to candidate screeners basing resume screening decisions on subjective criteria resulting in fewer or more resumes reaching the recruiter than desired.

### SUMMARY

A recruitment screening tool may objectively screen candidates for one or more open job positions based on the candidate's resumes. The tool may be configured to receive candidate resumes and generate a resume score for each candidate resume based on input representative of a comparison of information included in each candidate resume to predetermined resume criteria. Each resume score may be compared to a resume scoring scale having at least one scoring threshold. Each resume having an associated resume score greater than the first scoring threshold may be selected for review by a candidate recruiter. The score-selected resumes may be transmitted automatically to or may be retrieved by the candidate recruiter. Each resume may also be manually scored by a candidate screener independent of the candidate recruiter.

The tool may also identify each candidate resume having at least a predetermined number of predetermined keywords. The tool may determine the percentage of keyword-identified resumes also included in the score-selected resumes. If the percentage is outside a predetermined threshold percentage band, a quality alert may be generated and provided to the candidate recruiter. Accordingly, in one example, the recruitment screening tool may be used to confirm that the scoring performed by the candidate screener is objective and consistent.

The tool may also generate at least one statistic based on content present in keyword-selected resumes and score-selected resumes. The at least one statistic may be based on at least one predetermined analysis factor.

Further objects and advantages of the present invention will be apparent from the following description, reference being made to the accompanying drawings wherein the preferred embodiments of the present invention are clearly shown.

### BRIEF DESCRIPTION OF THE DRAWINGS

The innovation may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a block diagram of an example recruitment screening tool having a candidate screening module executable on a computer device.

FIG. 2 is an example of a scoring template implemented by the recruitment screening tool of FIG. 1.

FIG. 3 is an example of the completed scoring template of FIG. 2.

FIG. 4 is an example of a resume scoring scale implemented by the recruitment screening tool of FIG. 1.

FIG. 5 is another example of a resume scoring scale implemented by the recruitment screening tool of FIG. 1.

FIG. 6 is a block diagram of the example recruitment screening tool of FIG. 1 including a quality control module.

FIG. 7 is a block diagram of the example recruitment screening tool of FIG. 1 including a statistical analysis module.

FIG. 8 is an example operation flow diagram for implementing the recruitment screening tool of FIG. 1.

FIG. 9 is an example operational flow diagram for implementing the recruitment screening tool of FIG. 6.

FIG. 10 is an example operational flow diagram for implementing the recruitment screening tool of FIG. 7.

### DETAILED DESCRIPTION

A recruitment screening tool may be configured to receive a plurality of resumes from numerous candidates for a job opening. The recruitment screening tool may be implemented by a candidate screener operating a candidate screener terminal. A candidate screening module included in the recruitment screening tool may be used by the candidate screener via a candidate screener terminal to manually provide one or more scores for each received resume based on predetermined scoring criteria that may be provided by a candidate recruiter. Each resume score may be compared to a predetermined screening scale having one or more scoring thresholds. Each resume score above at least one scoring threshold may indicate that a candidate should receive further consideration by a candidate recruiter. The associated resume may then be transmitted directly to a recruiter terminal or stored for subsequent retrieval by the candidate recruiter through the recruiter terminal. The recruitment screening tool may implement a quality control module to monitor the consistency and objectivity of candidate screeners performing the scoring. The quality control module may be used to identify keywords in resumes submitted by candidates. The quality control module may determine the number of resumes containing keywords versus the number of resumes selected based on the scoring provided by the candidate screeners. The recruiter terminal may be notified if the percentage of keyword-selected resumes included in score-selected resumes is less than or greater than a predetermined threshold percentage band. The recruitment screening tool may also include a statistical analysis module to determine various statistics regarding resume information. The candidate recruiter may rely on statistics generated by the statistical analysis module to determine if a human candidate screener has unwarranted biases against candidates with particular backgrounds or may determine other statistics regarding candidate backgrounds.

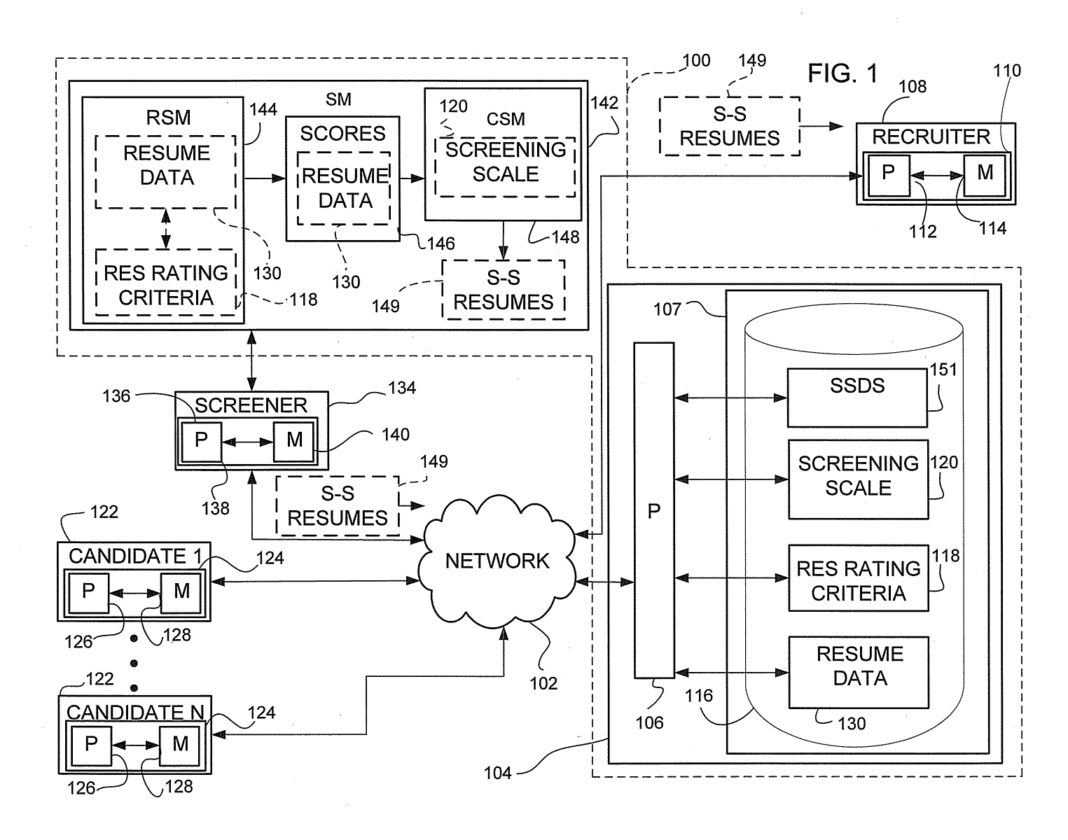

FIG. 1 shows a block diagram of a recruitment screening tool 100. In one example, the tool 100 may be implemented using a network 102. The network 102 may be an Internet-based, Intranet-based, directly connected, some combination thereof, or may employ other suitable network configurations. In one example, the tool 100 may include a computer device 104. The computer device 104 may include a processor (P) 106 and a memory 107. The memory 107 may include one or more memories and may be computer-readable storage media or memories, such as a cache, buffer, RAM, removable media, hard drive or other computer readable storage media. Computer readable storage media may include various types of volatile and nonvolatile storage media. Various processing techniques may be implemented by the processor 106 such as multiprocessing, multitasking, parallel processing and the like, for example. The processor 106 may include one or more processors.

In one example, a candidate recruiter may be responsible for reviewing candidate information regarding an open position with a particular employer. In some instances, the number of candidates may be extremely high. However, many candidates may lack the necessary background in one or more categories required for the position. As a result, the candidate recruiter may be required to review substantially more candidate information, such as candidate resumes, than desired due to unqualified candidates applying for an open position. Thus, the candidate recruiter may implement the recruitment screening tool 100 at a recruiter terminal to reduce the amount of candidate information the recruiter must analyze in selecting possible candidates for an open position. As described herein, the term “resume” may at least refer to any single or multiple documents describing an individual's background in any aspect relevant to a job opening. “Resume” may also include various similar documents such as a curriculum vitae (CV), cover letter, or any other document or documents containing relevant or requested information with regard to a job opening. “Resume” may also refer to both physical documents and documents stored on a computer-readable medium.

In FIG. 1, the recruitment screening tool 100 may utilize the computer device 104 as a server in a server/client relationship. A recruiter terminal 108 may access the computer device 104 via the network 102 with a computer device 110. The computer device 110 may include a processor (P) 112 and a memory (M) 114. The memory 107 may include a database 116. The database 116 may be configured to store a resume rating criteria 118 and a resume screening scale 120, as further described below. The resume rating criteria 118 may be preselected by the candidate recruiter or some other individual or group affiliated with the employer having an open position. The resume screening scale 120 may also be predetermined by the candidate recruiter or other affiliated individual or group.

Candidates may submit resumes or other information via the network 102 regarding an open position through candidate terminals 122. In FIG. 1, the candidate terminals are individually designated as candidate terminals 1 through N, which may illustrate that any number of candidate terminals 122 may be used by candidates to apply for an open position. The recruitment screening tool 100 may provide a candidate interface system such as an Internet portal or other suitable network connection, allowing each candidate to submit a resume regarding an open position through candidate terminals 122. As illustrated in FIG. 1, each candidate terminal 122 may include a computer device 124 having a processor (P) 126 and a memory (M) 128. Thus, each candidate terminal 122 may be used by a candidate to access the candidate interface system from a remote location. In alternative examples, the network 102 may be a direct network having a preselected number of candidate terminals 122, such as a kiosk-type arrangement for example, with access to the candidate interface system. In the alternative example, multiple candidates may submit resumes and other information via the same or different candidate terminal 122 of the preselected computer devices.

Each candidate may submit resume information, which may include a resume and other supplemental information relating to personal information, professional information, or other information aspects. The candidate interface system may receive this information and store the information in a resume data set 130, which may include resumes for each candidate. A candidate screener terminal 134 may also receive the resume data set 130 or indication of additions to the resume data set 130. The candidate screener may access the database 116 via the network 102 at the candidate screener terminal 134 that may include a computer device 136 having a processor (P) 138 and a memory (M) 140. The candidate screener may implement the recruitment screening tool 100 via the candidate screening terminal 134. In one example, the recruitment screening tool 100 may include a plurality of executable modules such as a screening module (SM) 142. As described herein, the modules are defined to include software, hardware or some combination thereof executable by the processor 106. Software modules may include instructions stored in the memory 107, or other memory device, that are executable by the processor 106 or other processor. Hardware modules may include various devices, components, circuits, gates, circuit boards, and the like that are executable, directed, and/or controlled for performance by the processor 106. The screening module 142 may be configured to screen out resumes of unqualified candidates allowing the recruiter terminal 108 to receive a smaller number of resumes than received through initial submission by the candidates.

In one example, the screening module 142 may include a resume scoring module (RSM) 144. The resume scoring module 144 may receive the resume data set 130 and the resume rating criteria 118. In one example, the candidate screener may manually compare each individual resume included in the resume data set 130 to the resume rating criteria 118. Based on this comparison the resume scoring module 144 may generate a score for each resume in the resume data set 130. The resume scoring module 144 may generate a score data set 146 that includes the generated scores, as well as the resume data set 130 used to reference each score to the respective candidate. The score data set 146 may be received by a candidate selection module (CSM) 148 configured to select resumes of particular candidates having resume scores above or within a particular scoring threshold.

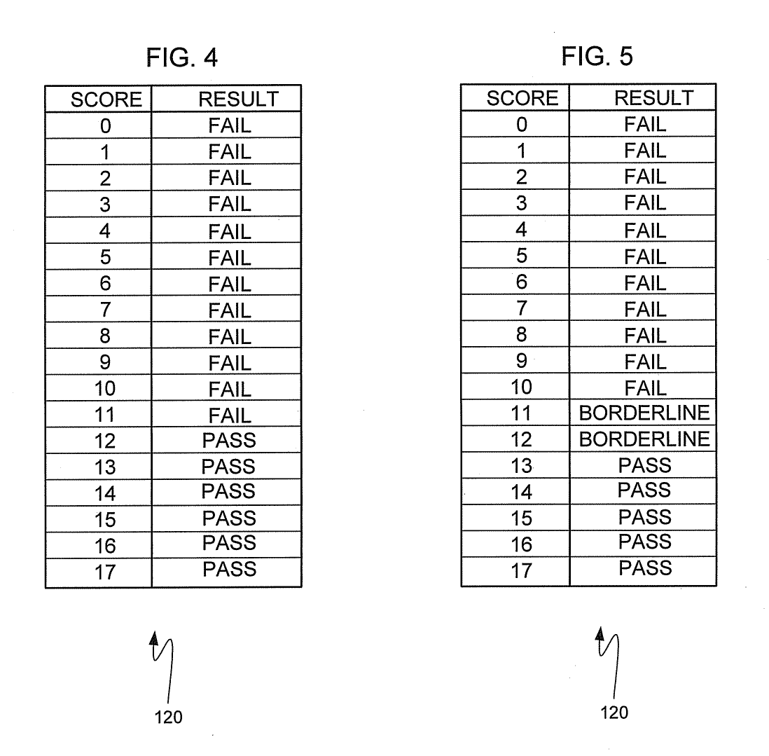

In one example, the candidate selection module 148 may implement the screening scale 120 stored in the database. The screening scale 120 may be configured to provide scoring bands (see FIGS. 4 and 5) for comparison to the resume scores, thereby allowing particular resumes to be screened out from consideration by the candidate recruiter. In one example, the screening scale 120 may include a scoring threshold. If a particular resume score is less than the threshold, the respective resume will not be forwarded on to the candidate recruiter at the recruiter terminal 108. If a particular resume score is greater than the threshold, the respective resume will be forwarded on to the respective candidate recruiter for further consideration. Other scoring band arrangements may be configured, as described with regard to FIGS. 4 and 5.

The candidate selection module 148 may select resumes to be considered by the candidate recruiter. Score-selected resumes 149 may be identified by the recruitment screening tool 100 based on input from the candidate screener terminal 134 from the candidate screener. The recruitment screening tool 100 may store the score-selected resumes 149 in the database 116 within a score-selected (SSDS) data set 151. The candidate recruiter may access the database 116 to retrieve the score-selected resumes 149 through the recruiter terminal 108. The recruitment screening tool 100 may be configured to automatically transmit the score-selected resumes 149 to the recruiter terminal 108 upon respective scoring of each particular resume. In other examples, the recruitment screening tool 100 may be configured to store a predetermined number of score-selected resumes 149 or store score-selected resumes 149 for a predetermined amount of time prior to being transmitted to the recruiter terminal 108 or may alert the recruiter terminal 108 that one or more score-selected resumes 149 are available for review. The recruitment screening tool 100 may be configured to rank the score-selected resumes 149 based on the associated score. In other examples, the candidate recruiter may access the database 107 via the recruiter terminal 108 to receive the score-selected resumes 149 having the highest score first, or the score-selected resumes 149 may be automatically transmitted to the recruiter terminal 108 in descending order of ranking.

In FIG. 1 a single candidate screener is described as interacting with the recruitment screening tool 100. However, multiple candidate screeners may interact with the recruitment screening tool 100 through a single or multiple candidate screener terminals 134. For example, multiple candidate screeners may screen candidates with respect to the same open position. In other examples, one or more candidate screeners may be responsible for screening candidates with regard to one or more different open positions.

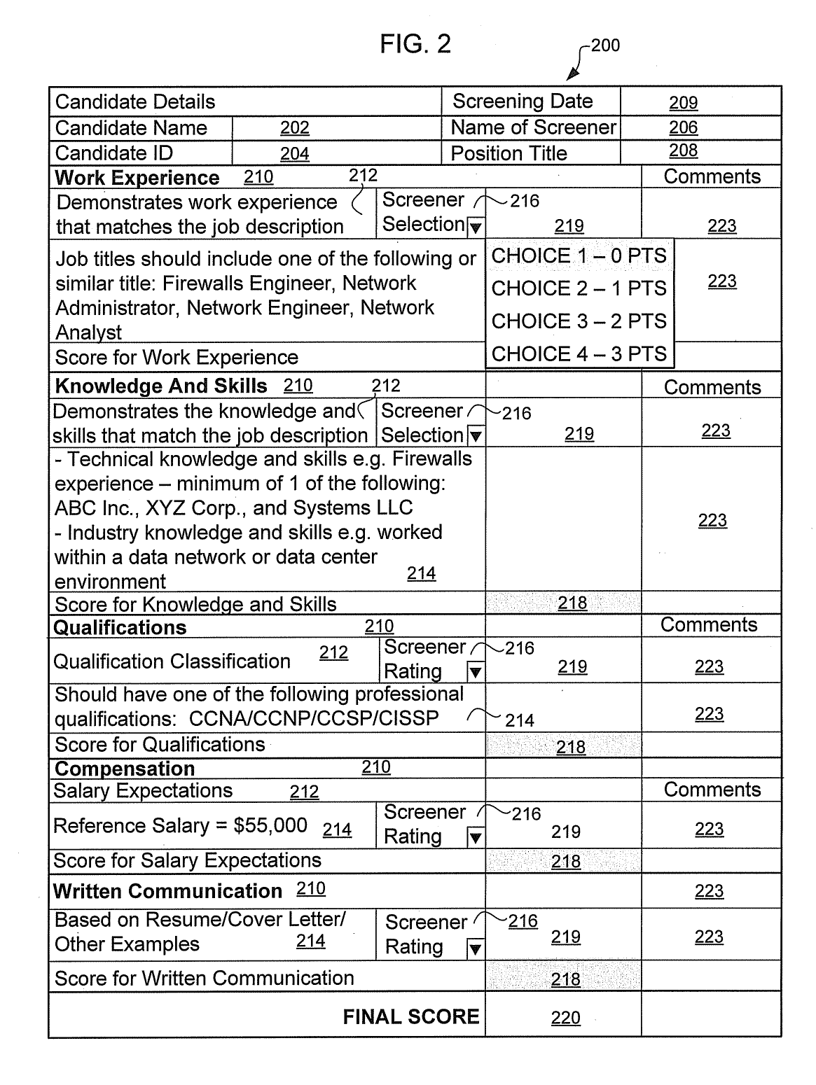

FIG. 2 shows an example of a scoring template 200 that may be implemented by the candidate screening tool 100. In one example, the template 200 may be accessed by the candidate screener at the candidate screening terminal 134 through the resume scoring module 144 in order to score the resume data set 130 against the resume rating criteria 118. The candidate screener may provide input into various fields of the template 200. Each template 200 may include information related to a particular candidate (“Candidate Details”). For example, in FIG. 2 the template 200 includes a “Candidate Name” input field 202, and a “Candidate ID” input field 204. The template 200 may also include a “Name of Screener” input field 206, “Position Title” input field 208, and a “Screening Date” input field 209. In FIG. 2, the template 200 is configured for an open position for a firewall engineer. Alternatively, data could be scanned and placed in the template using word recognition technology.

The template 200 may be configured to include several categories 210 on which to evaluate a resume. In FIG. 2, the example template 200 includes the categories 210 of “Work Experience,” “Knowledge and Skills,” Qualifications,” “Compensation,” and “Written Communication.” Each category may include a category definition field 212 that may be filled by a candidate recruiter to provide a category definition for the candidate screener. For example, a candidate may define the “Work Experience” category as “Demonstrate's work experience that matches the job description.” In FIG. 2, each category definition is shown for each category 210 in the example template 200.

Each category 210 may also include a category example/reference field 214. The category example/reference field 214 may contain keywords or required criteria provided by the candidate recruiter that the candidate recruiter desires to be present in a candidate's resume. Each category example/reference field 214, where applicable, for each category example/reference field 214 is shown in the example template 200 of FIG. 2.

The candidate screener may score each candidate resume for each category 210. In one example, the template 200 may include a “Screener Selection” field 216 in which to select a score for a particular category. In one example, the screener selection field 216 may be configured as a drop-down menu as illustrated in FIG. 2. In FIG. 2, the screener selection field 216 for the work experience category 210 is shown as being dropped down for selection. In FIG. 2, the screener selection field 216 may include a plurality of scoring choices from which the candidate screener may choose. In FIG. 2, the screener selection field 216 includes generic choices 1 through 4 for illustrative purposes. Each choice may describe a particular degree to which a candidate resume addresses a particular category 210. Each choice includes a score, with a higher score representing that a candidate resume more appropriately addresses a particular category as compared to a lower score. Each selection for a category 210 may be indicated in a selection indication field 219. Table 1 provides example choices and associated scores for each of the categories 210.

TABLE 1

| Category | Available Choices | Score |
|---|---|---|
| Work | Choice 1 - No relevant work experience with 0% | 0 Pts. |
| Experience | match to requirements. | |
| | Choice 2 - Limited relevant work experience with <40% | 1 Pt. |
| | relevance to requirements. | |
| | Choice 3 - Good level of experience with >60% | 3 Pts. |
| | match to requirements. | |
| | Choice 4 - Highly relevant work experience with >80% | 5 Pts. |
| | match to requirements. | |
| Knowledge | Choice 1- No relevant knowledge or skills with 0% | 0 Pts. |
| and Skills | match to requirements. | |
| | Choice 2 - Limited relevant knowledge or skills with <40% | 1 Pt. |
| | relevance to requirements. | |
| | Choice 3 - Good level of knowledge or skills with >60% | 3 Pts. |
| | match to requirements. | |
| | Choice 4- Highly relevant knowledge or skills with >80% | 5 Pts. |
| | match to requirements. | |
| Qualifications | Choice 1 - No relevant qualification. | 0 Pts. |
| | Choice 2 - Part qualified or studying in progress. | 1 Pt. |
| | Choice 3 - Has all relevant qualifications. | 3 Pts. |
| Compensation | Choice 1 - If above $5,000. | 0 Pts. |
| | Choice 2 - If within $7,500 above or below. | 1 Pt. |
| | Choice 3 - If within $10,000 above or below. | 2 Pts. |
| | Choice 4 - If within salary band. | 3 Pts. |
| Written | Choice 1 - Poor grammar/spelling. | 0 Pts. |
| Communication | Choice 2 - Good use of grammar/spelling. | 1 Pt. |

As the candidate screener progresses through the template 200 each category 210 may be addressed. With regard to the work experience category 210, the candidate recruiter may list employers in the category example/reference field 212 that the candidate recruiter prefers candidates to be currently or have been previously employed. As indicated in Table 1, the choices for the screener selection field 216 for particular categories 210 may be based on the percentages of how relevant a candidate's listed work experience is to the candidate recruiter's preferences.

With regard to the knowledge and skills category 210, the candidate recruiter may input a list of preferred skills and knowledge in the example/reference field 212. The candidate screener may compare the candidate recruiter's list of preferred skills and knowledge to each candidate resume. Based on this comparison, the candidate screener may manually select the best choice from the list in the screener selection field 216. The choices for the knowledge and skills category 210 may be the choices listed in Table 1, however, other choices may be used by the candidate recruiter.

With regard to the qualifications category 210, the candidate recruiter may input a list of preferred professional qualifications for a candidate to have achieved in the example/reference field 212. The candidate screener may compare a candidate's resume to the choices in the screener rating field 216 for the qualifications category 210 and select the appropriate choice. With regard to the compensation category 210, the candidate recruiter may select a reference salary/compensation for an open position. For example, in FIG. 2, a salary of $55,000 has been established as the reference compensation. The choices may involve how closely a candidate's compensation request is to the reference salary, such as described in Table 1 for example. With regard to the written communication category 210, the candidate recruiter may desire that the candidate screener determine a candidate's written communication skills level based on the candidate's resume. Table 1 provides an example of the choices from which the candidate screener may select to evaluate written communication skills of a candidate 122.

Upon selection of a choice for each category 210, the associated score may be generated in the scoring field 218. The scores for each category 210 may represent sub-scores that are summed by the recruitment screening module 142 to generate a final score appearing in a final score field 220. The template 200 may also include comment fields 223 that may be used by the candidate screener to enter various comments that may be later viewed. Each completed template 200 may be stored in the database 116 or other memory location. A candidate recruiter may retrieve the templates 200 via the recruiter terminal 108 to review the scoring selections of the candidate screeners, or the completed templates may be automatically transmitted directly to the recruiter terminal 108. In one example, each of the score-selected resumes 149 may be stored in the score-selected (S-S) resume data set 151 along with the associated completed template 200. Each score-selected resume 149 retrieved by or transmitted to the recruiter terminal 108 may automatically include the associated completed template 200.

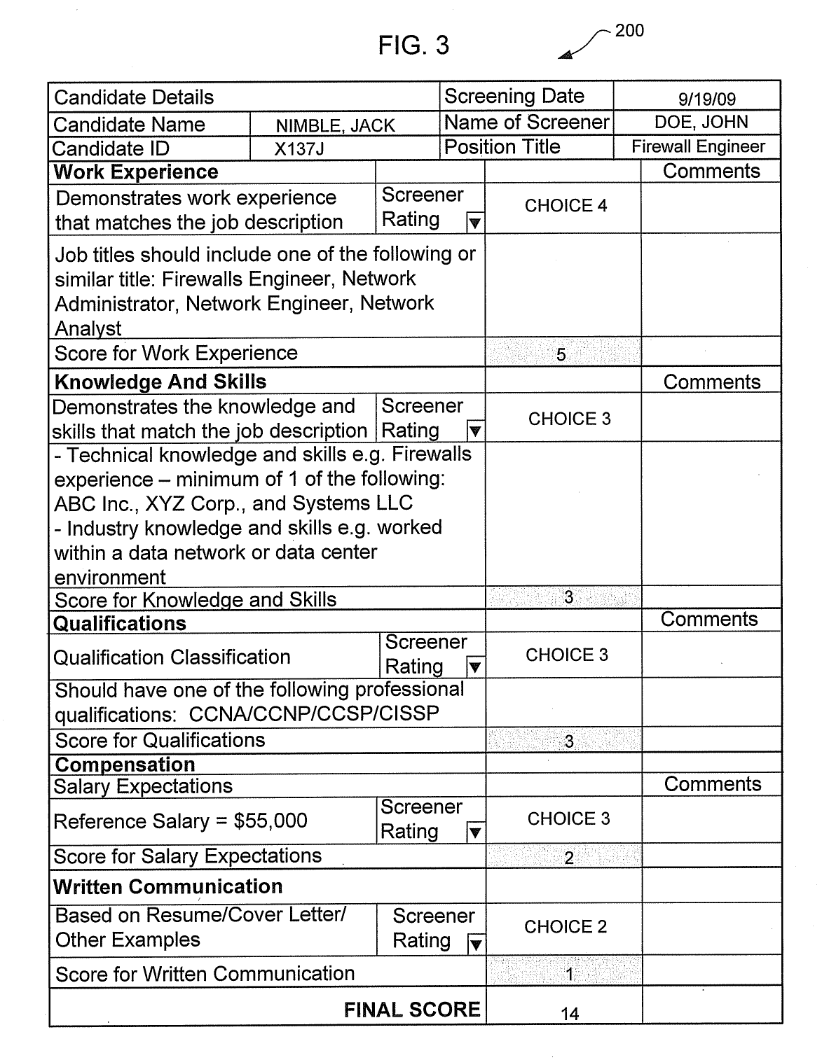

FIG. 3 is an example of the template 200 completed by the candidate screener via the candidate screener terminal 134 using the scoring criteria in Table 1. The candidate in the example of FIG. 3 has a final score of 14 out of a maximum possible score of 17 points. Upon generation of the final score, the score may be compared to the screening scale 120 by the candidate screening module 148. FIG. 4 is an example screening scale 120 in which any final score greater than 11 points results in the candidate's resume being selected for forwarding to the recruiter terminal 108 and is designated as “PASS.” A final score less than 12 points results in a candidate's resume not being selected for forwarding to the recruiter terminal 108 and is designated as “FAIL.”

FIG. 5 shows an alternative screening scale 120 in which a score greater than 12 points results in a candidate's resume being forwarded to the recruiter terminal 108. A score of less than 11 points results in the candidate's resume not being forwarded to the recruiter terminal 108. A score of 11 points or 12 points results in the resume being designated as BORDERLINE. The resumes designated as BORDERLINE may provide a distinction from the resumes having higher resume scores. The resumes having higher resume scores in the PASS score range may be reviewed by the recruiter prior to the resumes within the BORDERLINE score range.

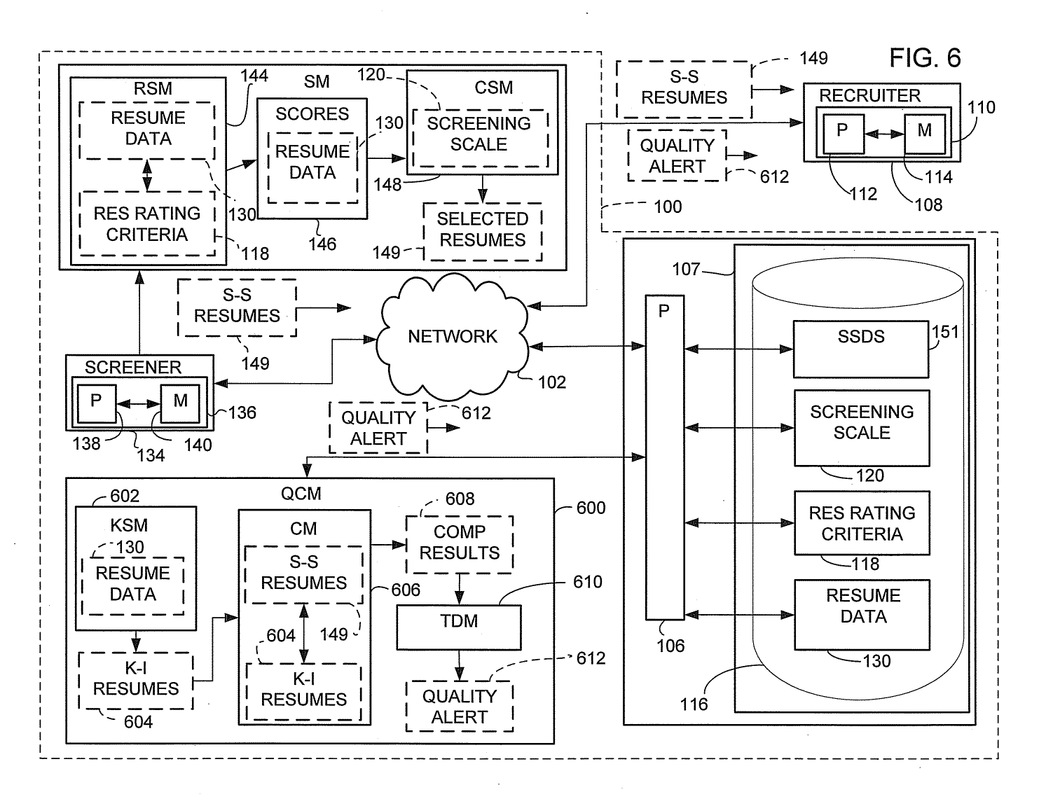

Although the recruitment screening tool 100 is configured to reduce the amount of resumes received by the candidate recruiter, the candidate recruiter may not be able to monitor the quality of the candidate screener utilizing the screening module 142. In the example system of FIG. 6, the recruitment screening tool 100 may include a quality control (QCM) module 600. As described with regard to FIG. 1, each candidate resume may be stored in the resume data set 130. The quality control module 600 may receive the resume data set 130 containing all current resumes or may receive each resume one-by-one as the resume is stored in the resume data set 130. The quality control module 600 may implement a keyword search module (KSM) 602 on the resumes in the resume data set. The selected keywords may be predetermined, such as by the candidate recruiter, or may be extracted from the information in the template 200. The keyword search module 602 may identify resumes from the resume data set 130 having a predetermined amount of keywords, certain combinations of keywords, or some other criteria for filtering based on keywords being present in the resumes.

The keyword search module 602 may provide keyword-identified (K-I) resumes 604 to a comparison module (CM) 606. The comparison module 606 may compare the keyword-identified resumes 604 to the score-selected resumes 149. The comparison module 606 may determine the percentage of keyword-identified resumes 604 included in the score-selected resumes 149 resulting from the manual scoring by the candidate screener. The comparison module 606 may generate a comparison results data set 608. In one example, the comparison results data set 608 may include a percentage of resumes in the keyword-identified resumes 604 that are also included in the score-selected resumes 149. In alternative examples, the comparison module 606 may compare the number of keyword-selected resumes 604 to the number of score-selected resumes 149.

The comparison results data set 608 may be provided to a threshold detection module 610. The threshold detection module (TDM) 610 may be configured to generate a quality alert 612 when the percentage included in the comparison results data set 608 is outside a predetermined threshold percentage band. The quality alert 612 may be transmitted to the recruiter terminal 108 to notify the candidate recruiter that a particular candidate screener may be failing to identify candidates that the candidate recruiter would prefer to also evaluate. The quality alert 612 may also be transmitted to the recruiter terminal 108 to notify the candidate recruiter that a particular candidate screener may be identifying too many candidates as possibilities through the scores being manually selected by the candidate screeners.

The quality alert 612 may be beneficial if the candidate screener who has control of the candidate screening prevents the recruiter from viewing resumes or provides too many due to incorrect scores. Thus, the quality alert 612 allows the candidate recruiter to have a quality control measure to ensure that the candidate screener is accurately scoring the candidate resumes objectively. The predetermined threshold of the threshold detection module 610 may be set at a percentage band that allows the candidate screener some discretion in scoring the resumes such that the recruiter terminal 108 is not notified in every instance of a resume not scored correctly by the candidate screener being identified by the keyword search module 602.

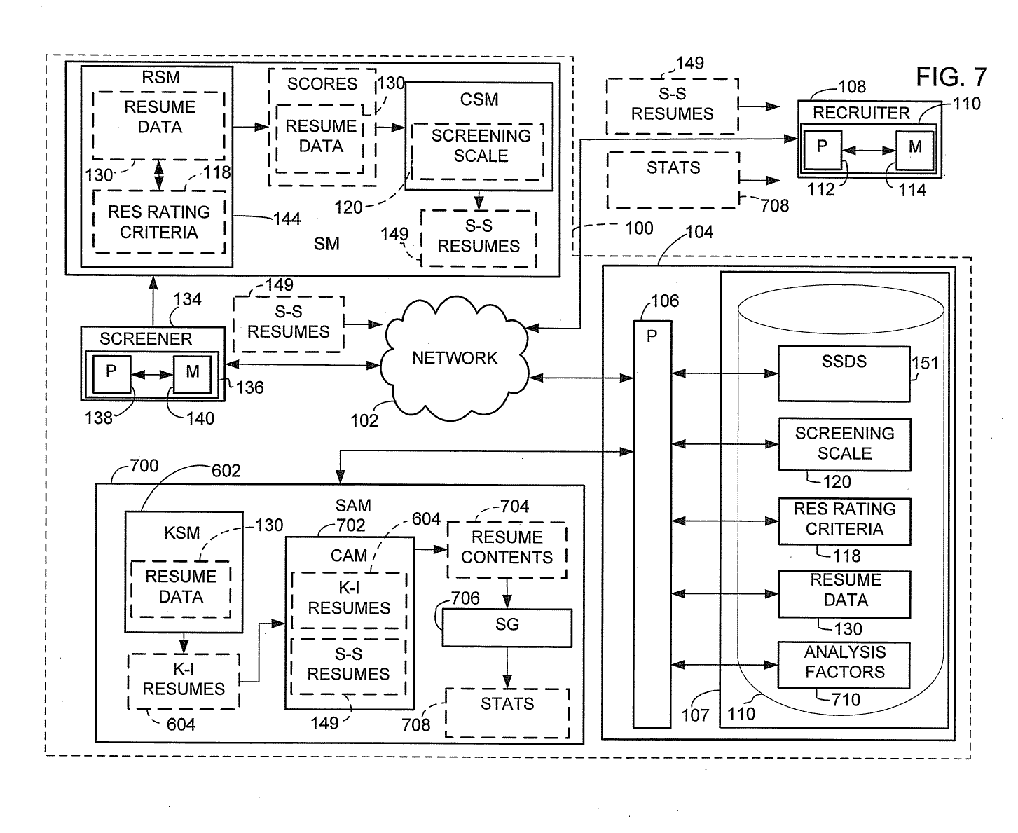

A candidate recruiter may desire to receive various statistics regarding candidates 122 with respect to various reference factors. FIG. 7 shows the recruitment screening tool 100 as including a statistical analysis module (SAM) 700 configured to perform various statistical analyses with regard to the resume data set 130. In one example, the statistical analysis module 700 may include the keyword search module 602. As similarly described with regard to FIG. 6, the keyword search module 602 may identify predetermined keywords in resumes contained in the resume data set 130. The predetermined keywords may be selected by the candidate recruiter. The predetermined keywords may be directed towards categories, such as those described with regard to the template 200, as well as towards other categories, such as education, personal background information, non-professional activities, organizations, etc.

The keyword selection module 602 may identify the plurality of keyword-identified resumes 604 containing a predetermined number of keywords. The keyword-identified resumes 604 may be provided to a content analysis module (CAM) 702. The content analysis module 702 may be configured to analyze the keyword-identified resumes 604 and the score-selected resumes 149 to determine particular content associated with the keyword-identified resumes 604 and the score-selected resumes 149. The analysis involved with the content analysis module 702 may be associated with identifying phrases or relationships between keywords identified with the keyword search module 602 to determine if particular content is present in the keyword-identified resumes 604 and the selected resumes 149 such as specific educational backgrounds (e.g., particular universities) or professional activities (e.g., IEEE).

The content analysis module 702 may generate the identified resume content data set 704. The resume content data set 704 may be received by a statistics generator (SG) module 706. The statistics generator module 706 may be configured to determine various statistics with regard to the resume content data set 704. For example, a candidate recruiter may desire to know how many candidates attended a particular university and/or had a particular major. The statistics generator module 706 may be configured to make such assessments. Furthermore, the statistics generator module 706 may be configured to generate statistical comparisons of the score-selected resumes 149 and the keyword-identified resumes 604. For example, a candidate recruiter may desire to determine if the candidate screener has some unwarranted bias against candidates having particular backgrounds. The statistics generator module 706 may be configured to generate statistics regarding the number of candidates having particular backgrounds whose resumes are included in the keyword-identified resumes 604 compared to the candidates' resumes present in the score-selected resumes 149. In one example, an analysis factors data set 710 may be implemented by the statistics generator module 706. The analysis factors data set 710 may be predetermined by the candidate recruiter or other party and stored in the database 116. The analysis factors data set 710 may be configured to provide the statistics generator module 706 the various aspects for determining the statistics in the statistics data set 708.

Thus, based on such statistics, the candidate recruiter may determine if a candidate screener may have unnecessary and/or inappropriate biases against candidates due to some particular quality of a candidate described in the candidate's resume. The statistics generator module 706 may be configured to generate a statistics data set 708 including statistics generated by the statistics generator module 706. The statistics data set 708 may be transmitted to the recruiter terminal 108 and/or stored in the database 116.

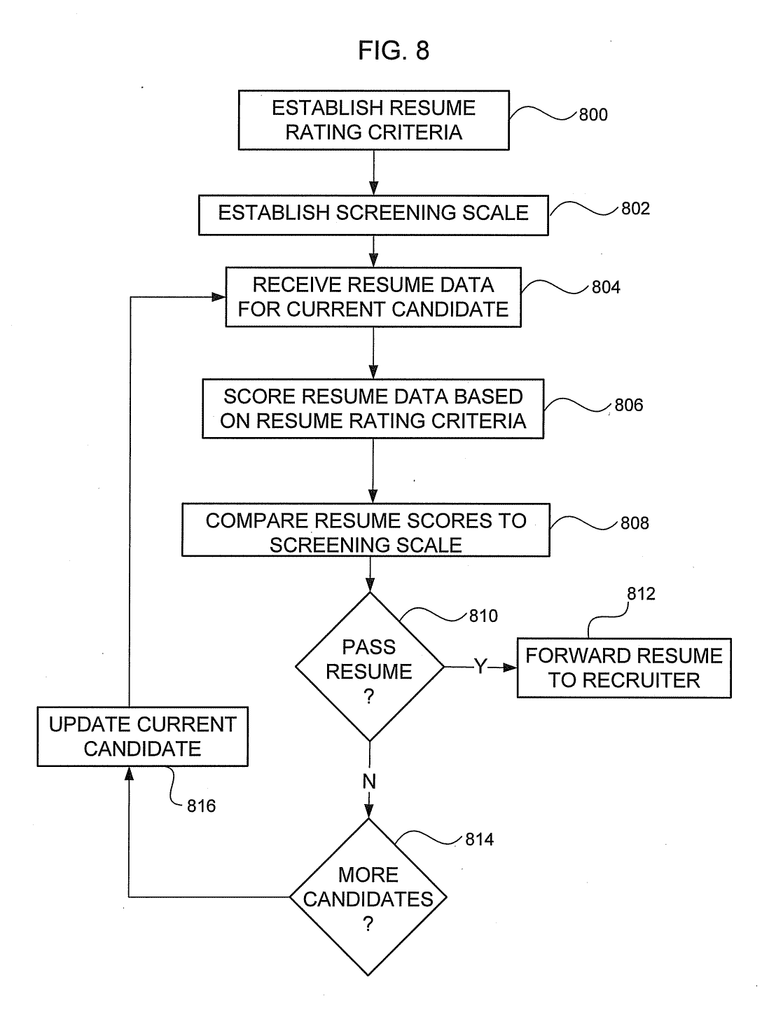

FIG. 8 is an example operational flow diagram of the recruitment screening tool 100 shown in FIG. 1. At block 800, the resume rating criteria 118 may be established. In one example, the resume rating criteria 118 may be predetermined and stored in the database 116. At block 802, the screening scale criteria 120 may be established. In one example, the screening scale criteria 120 may be predetermined and stored in the database 116. At block 804, resume data for a candidate may be received. In one example, the candidate screener may receive the resume data set 130 from the database 116 via the network 102 at the candidate screener terminal 134. The resume data set 130 may include one or more candidate resumes to be reviewed by the candidate screener.

At block 806, a candidate resume may be manually scored by the candidate screener based on the resume rating criteria 118 with the resume scoring module 144. In one example, the resume scoring module 144 may be used in manner such as through the template 200 at the candidate screener terminal 134. The candidate screener terminal 134 may generate a score through candidate screener input for a resume of a candidate based on a comparison between the candidate resume and the resume rating criteria 118. The template 200 may receive a plurality of sub-scores selected by the candidate screener and the resume scoring module 144 may generate an overall resume score for a resume by summing the sub-scores associated with the resume. At block 808, the recruitment screening tool 100 may compare the score generated by the resume scoring module 144 to the screening scale 120. In one example, the candidate selection module 148 may perform the comparison. The screening scale 120 may vary in configuration as described with regard to FIGS. 4 and 5. At block 810, a determination may be made as to whether or not the scores generated at block 808 are to be forwarded to the recruiter via the recruiter terminal 108 based on the screening scale 120. If the score is deemed passing, the score-selected resume 149 may be forwarded to the recruiter terminal 108 at block 812. Upon forwarding the score-selected resume 149 or upon determining the resume is to not be forwarded to the recruiter, at block 814 a determination is made if there are other candidates for a position being screened by the candidate screener. If other candidates exist, at block 816 the current candidate may be updated to the next resume in the resume data set 130, and the screening process may be performed beginning at block 804.

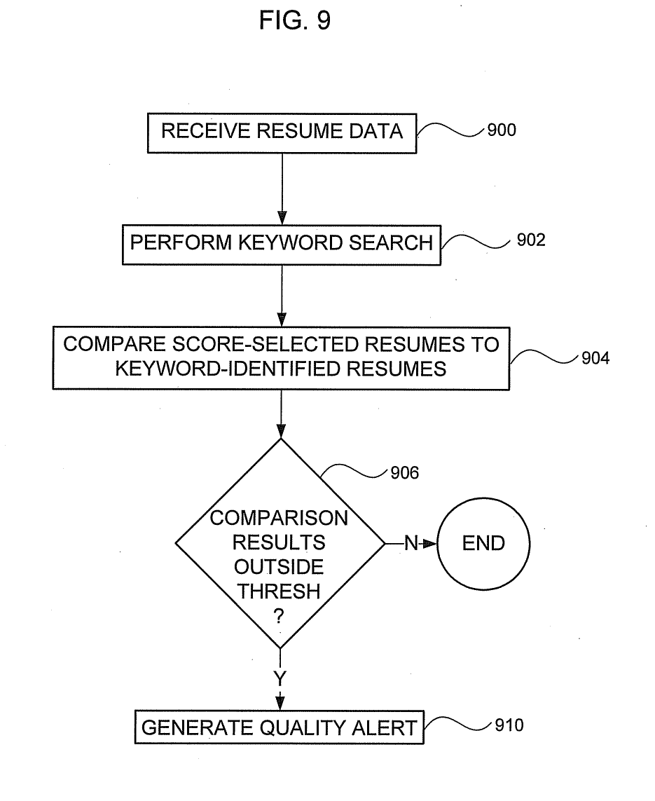

FIG. 9 is an example operational flow diagram of the recruitment screening tool 100 shown in FIG. 6 including the quality control module 600. At block 900, resume data set 130 may be received by the quality control module 600. The resume data set 130 may include resumes of various candidates for one or more position openings. At block 902, a keyword search of the resume data set 130 may be performed by the keyword search module 602 to identify keyword-selected resumes 604 in the resume data set 130 having the keywords predetermined or selected by the keyword search module 602. At block 904, a comparison may be performed by the comparison module 606 between the score-selected resumes 149 and the keyword-identified resumes 604 by keyword search module 602 to determine a percentage of the keyword-selected resumes 604 also included in the score-selected resumes 149.

At block 906, the determined percentage may be compared by the threshold detector module 610 to a predetermined threshold percentage band. If the comparison results are outside a threshold band, the quality alert 612 is sent to the recruiter terminal 108. If the results are within the threshold band, the quality control module 600 performance may end. Alternatively, the quality control module 600 may continuously or periodically operate such allowing running comparisons by the comparison module 606.

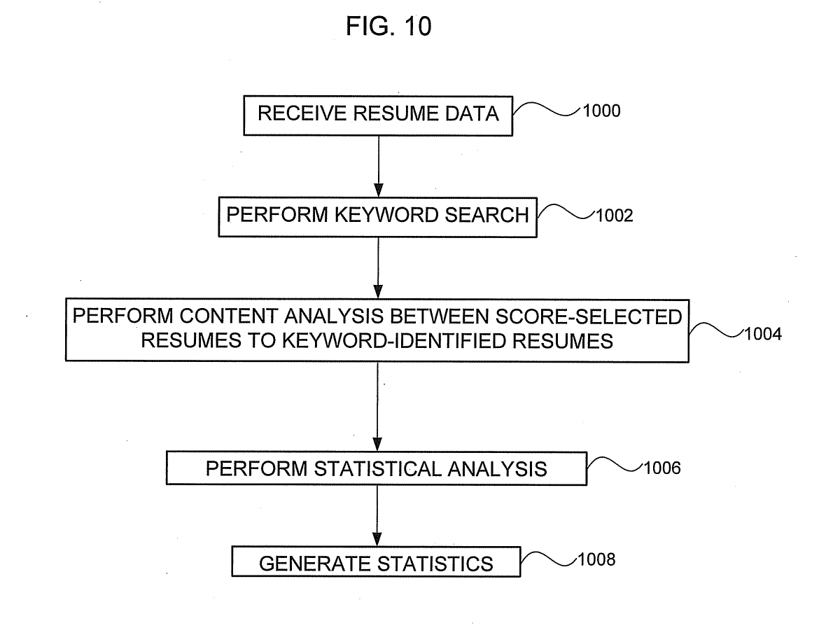

FIG. 10 shows an example operational flow diagram describing an operation of the recruitment screening tool 100 shown in FIG. 7 including the content analysis module 600. At block 1000, resume data set 130 may be received by the content analysis module 700. The resume data set 130 may include resumes of various candidates for one or more position openings. At block 1002, a keyword search of the resume data set 130 may be performed by the keyword search module 602 to identify the resumes in the resume data set 130 having the keywords predetermined or selected by the keyword module 602.

At block 1004, a content analysis may be performed by the content analysis module 702 between the score-selected resumes 149 and the keyword-identified resumes 604 based on the keyword search module 602 to generate the resume content data set 704. At block 1006, a statistical analysis may be performed on the resume content data set 704 by the statistics generator module 706. At block 1008, the statistics data set 708 may be generated by the statistics generator module 706. The statistics data set 708 may be uploaded to the database 116 for subsequent download by the recruiter terminal 108 or may be directly transmitted to the recruiter terminal 108.

While various embodiments of the innovation have been described, it will be apparent to those of ordinary skill in the art that many more embodiments and implementations are possible within the scope of the innovation. Accordingly, the innovation is not to be restricted except in light of the attached claims and their equivalents.

We claim:

1. A recruitment screening tool comprising:
a database configured to store a resume data set including a plurality of resumes, predetermined resume rating criteria, and a screening scale having a first scoring threshold;
a resume scoring module executable by a processor to:
receive the plurality of resumes from the resume data set;
receive a respective plurality of sub-scores for each of the plurality of resumes, wherein each of the respective plurality of sub-scores is based on a comparison between one of the plurality of resumes and the predetermined resume rating criteria; and
generate a respective resume score for each of the plurality of resumes based on the respective plurality of sub-scores;
a resume screening module executable by the processor to:
receive each respective resume score;
compare each respective resume score to the screening scale; and
identify each resume having a respective resume score above the first scoring threshold; and
transfer each identified resume from the resume data set to a score-selected resume data set stored in the database.

2. The recruitment screening tool of claim 1, wherein the predetermined resume screening criteria includes at least one criteria category selected from a group consisting of work experience, professional skills, qualifications, desired compensation, and written communication skills.

3. The recruitment screening tool of claim 1, wherein the resume screening module includes a predetermined number of scoring levels associated with at least one of the predetermined resume rating criteria.

4. The recruitment screening tool of claim 1, wherein the screening scale includes a second scoring threshold below the first scoring threshold, and wherein the resume screening module is further executable to identify each resume having the respective resume score below the first scoring threshold and above the second scoring threshold; and
transfer each identified resume having the respective resume score below the first scoring threshold and above the second scoring threshold from the resume data set to a score-selected resume data set.

5. The recruitment screening tool of claim 1, wherein the resume screening module is further executable to hierarchically rank each resume identified as having the respective resume score above the first scoring threshold, the ranking based on the respective resume score; and
wherein each resume identified as having a respective resume score above the first scoring threshold is automatically transferred to an employment recruiter in a descending order of rank.

6. The recruitment screening tool of claim 1 further comprising a quality control module comprising:
a keyword search module executable by the processor to identify resumes from the plurality of resumes having at least a predetermined number of predetermined keywords;
a resume comparison module executable by the processor to determine a percentage of a number of resumes identified as having the at least a predetermined number of predetermined keywords included in the number of identified resumes having respective resume scores greater than the first scoring threshold; and
a threshold detection module executable by the processor to:
compare the determined percentage to a predetermined threshold percentage band; and
generate an alert message in response to the determined percentage being outside the predetermined threshold percentage band.

7. The recruitment tool of claim 1 further comprising a content analysis module comprising:
a keyword search module executable by the processor to select resumes containing at least a predetermined number of predetermined keywords;
a content comparison module executable by the processor to determine existence of predetermined content in the selected resumes and identified resumes; and
a statistics generator module executable by the processor to generate at least one statistic based on at least one predetermined analysis factor and the predetermined content determined to exist by the content comparison module.

8. A computer-readable medium comprising a plurality of instructions executable by a processor, the computer-readable medium comprising:
instructions to retrieve a plurality of resumes from a resume data set stored in a database;
instructions to retrieve a predetermined resume rating criteria stored in the database;
instructions to execute a resume scoring module executable to:
receive a respective plurality of sub-scores for each of the plurality of resumes, wherein each of the respective plurality of sub-scores is based on a comparison between one of the plurality of resumes and the predetermined resume rating criteria; and
generate a respective resume score for each of the plurality of resumes based on the respective plurality of sub-scores;
instructions to retrieve a resume screening scale having a first scoring threshold from the database;
instructions to execute a resume screening module executable to:
receive each respective resume score;
compare each respective resume score to the resume screening scale; and
identify each resume having a respective resume score above the first scoring threshold; and
instructions to transfer each identified resume from the resume data set to a score-selected resume data set.

9. The computer-readable medium of claim 8, wherein the instructions to retrieve a predetermined resume rating criteria stored in the database comprises instructions to retrieve at least one criteria category based on work experience, professional skills, qualifications, desired compensation, and written communication skills.

10. The computer-readable medium of claim 8, wherein the instructions to execute the resume scoring module further comprises instructions to generate a respective resume score for each of the plurality of resumes based on the comparison between one of the plurality of resumes and the predetermined resume rating criteria.

11. The computer-readable medium of claim 8, wherein the screening scale includes a second scoring threshold below the first scoring threshold, and wherein the instructions to execute the resume screening module comprise instructions to:
execute a resume screening module to identify each resume having a respective resume score below the first scoring threshold and above the second scoring threshold; and
transfer each identified resume having a respective resume score below the first scoring threshold and above the second scoring threshold from the resume data set to a score-selected resume data set.

12. The computer-readable medium of claim 8, wherein the instructions to execute the resume screening module further includes instructions to:
rank each resume identified as having a respective resume score above the first scoring threshold based on the respective resume score; and
automatically transfer identified resumes to an employment recruiter in a descending order of rank.

13. The computer-readable medium of claim 8 further comprising instructions to execute a quality control module executable to:
perform a keyword search to identify resumes from the plurality of resumes having at least a predetermined number of predetermined keywords;
determine a percentage of the number of resumes identified as having at least a predetermined number of predetermined keywords included in the number of identified resumes having respective resume scores greater than the first scoring threshold;
compare the determined percentage to a predetermined threshold percentage band; and
generate an alert message in response to the determined percentage being outside the threshold percentage band.

14. The computer-readable medium of claim 8 further comprising instructions to execute a content analysis module executable to:
perform a keyword search to identify resumes from the plurality of resumes containing at least a predetermined number of predetermined keywords;
determine existence of predetermined content in the resumes identified as having at least a predetermined number of predetermined keywords and the number of identified resumes having respective resume scores greater than the first scoring threshold; and
generate at least one statistic based on at least one predetermined factor and the predetermined content determined to exist by the content comparison module.

15. A recruitment screening tool comprising:
a database configured to store a resume data set including a plurality of resumes, a predetermined resume rating criteria, and a screening scale including a first scoring threshold;
a candidate screening module executable to:
receive a respective plurality of sub-scores for each of the plurality of resumes, wherein each of the respective plurality of sub-scores is based on a comparison between one of the plurality of resumes and the predetermined resume rating criteria; and
generate a respective resume score for each of the plurality of resumes based on the respective plurality of sub-scores;
identify each resume of the plurality of resumes having a respective resume score greater than the first scoring threshold;
a quality control module configured to:
generate a quality alert based on a percentage of resumes included in both the plurality of resumes having a first predetermined number of predetermined keywords and the identified resumes being outside of a predetermined threshold percentage band; and
generate a quality alert message in response to the percentage being outside of the predetermined threshold percentage band; and
a statistics generator module executable by the processor to generate at least one statistic based on a comparison of content including in each identified resume and the number of resumes included in the plurality of resumes having a second predetermined number of keywords.

16. The recruitment screening tool of claim 15, wherein the candidate screening module is further executable to generate a plurality of input templates, wherein each of the plurality of input templates is configured to receive a respective input representative of one of the respective plurality of sub-scores.

17. The recruitment screening tool of claim 15, wherein each of the input templates includes a plurality of categories, wherein each of the plurality of categories is associated with predetermined resume content.

18. The recruitment screening tool of claim 16, wherein each respective input is a plurality of respective inputs based on a plurality of predetermined scoring levels.

19. The recruitment screening tool of claim 15, wherein the candidate screening module is further executable to identify a candidate for employment associated with a first job opening, wherein each identified candidate is associated with a resume of the plurality of resumes having a respective resume score greater than the first scoring threshold.

20. The recruitment screening tool of claim 15, wherein the candidate screening module is further executable to automatically transmit to a predetermined terminal each resume of the plurality of resumes having a respective resume score greater than the first scoring threshold.
